(19) United States
(12) Patent Application Publication
(10) Pub. No.: US 2006/0220872 A1
(43) Pub. Date: Oct. 5, 2006

(54) Mounting bracket

(76) Inventors: Mark Allen Brown, Memphis, TN (US); Gregory J. Castle, Wilder, KY (US)

Correspondence Address: INTERNATIONAL PAPER COMPANY, 6285 TRI-RIDGE BOULEVARD, LOVELAND, OH, 45140, US

(21) Appl. No.: 11/366,046

(22) Filed: Mar. 1, 2006

Related U.S. Application Data
(63) Continuation-in-part of application No. 11/269,299, filed on Nov. 8, 2005.
(60) Provisional application No. 60/657,657, filed on Mar. 1, 2005.

(51) Int. Cl. G08B 13/14

(52) U.S. Cl. 340/572.7; 700/214

(57) ABSTRACT

A mounting bracket is used for positioning an electronic device relative to a frame of a forklift truck. A base plate includes a pair of openings therethrough. Each of the pair of openings receives an electronic device therein. Each of the pair of openings includes an elongated recess extending from the opening of the base plate. The elongated recess permits the opening to be in communication with a region exterior to the base plate. A pair of hangers is connected to the base plate and each of the hangers is configured to engage with the forklift truck. A cover plate is configured to enclose each of the pair of the opening so as to protect the electronic device during operation of the forklift truck.

### CROSS-REFERENCE TO RELATED APPLICATIONS

The present application is a continuation-in-part application of U.S. patent application Ser. No. 11/269,299 entitled “Inventory tracking,” filed Nov. 8, 2005, and claims priority to U.S. Provisional Application Ser. No. 60/657,657, filed on Mar. 1, 2005, entitled “A Mount for a forklift truck”, which are here by incorporated, in their entirety, her in by reference.

### TECHNICAL FIELD

The present application relates to inventory tracking processes, systems and devices.

### BACKGROUND OF THE INVENTION

Radio frequency identification (“RFID”) technology has been used for wireless (i.e., non-contact, non-line of sight) automatic identification. An RFID system typically includes an RFID transponder, which is sometimes referred to as an inlet, inlay or tag, and an RFID reader. The transponder typically includes a radio frequency integrated circuit (“RFIC”) and an antenna. Both the antenna and the RFIC can be positioned on a substrate. The inlet, inlay or tag includes the antenna and may also include a substrate on which the antenna is positioned.

The RFID reader utilizes an antenna and a transceiver, which includes a transmitter, a receiver, and a decoder incorporating hardware and software components. Readers can be fixed, tethered, or handheld devices, depending on the particular application. When a transponder passes through the read zone of a reader, the transponder is activated by the electromagnetic field from the reader antenna. The transceiver decodes the data sent back from the transponder and this decoded information is forwarded to a host computer for processing. Data transfer between the transponder and transceiver is wireless.

RFID systems may utilize passive, semi-passive, or active transponders. Each type of transponder may be read only or read/write capable. Passive transponders obtain operating power from the radio frequency signal of the reader that interrogates the transponder. Semi-passive and active transponders are powered by a battery, which generally results in a greater read range. Semi-passive transponders may operate on a timer and periodically transmit information to the reader. Active transponders can control their output, which allows them to activate or deactivate apparatus remotely. Active transponders can also initiate communication, whereas passive and semi-passive transponders are activated only when they are read by another device first. Multiple transponders may be located in a radio frequency field and read individually or simultaneously.

Inventory tracking systems are currently being developed that utilize RFID technology. In some proposed systems, a hand-held reader may be used to scan a single RFID tag, which may then be used to identify a grouping of inventory components, for example, that are being transported together on a pallet. It is desirable to provide other inventory tracking systems and methods.

### SUMMARY OF THE INVENTION

One aspect of the present invention relates to a mounting bracket for positioning an electronic device relative to a stationary member. The mounting bracket comprises a base plate having at least one opening therethrough. The opening receives an electronic device therein. An elongated recess extends from the opening of the base plate and permits the opening to be in communication with a region exterior to the base plate. At least one hanger is connected to the base plate and is configured to engage with the stationary member.

In another aspect of the invention, a mounting bracket for positioning an electronic device relative to a frame of a forklift truck is disclosed. The mounting bracket comprises a base plate having a pair of openings therethrough wherein each of the pair of openings receives an electronic device therein. Each of the pair of openings includes an elongated recess extending from the opening of the base plate. The elongated recess permits the opening to be in communication with a region exterior to the base plate. A pair of hangers is connected to the base plate and each of the hanger being is configured to engage with the forklift truck. A cover plate is configured to enclose each of the pair of the opening so as to protect the electronic device. The mounting bracket is adjustable with respect to the frame. The mounting bracket may also be fixedly attached to the frame. The base plate includes a front surface and a back surface wherein the elongated recess are located in the back surface of the base plate.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective view of an embodiment of a system and method of identifying inventory;

FIG. 2 is a perspective view of an embodiment of a case;

FIG. 3 is a front view of an embodiment of a power-operated mechanism for use in the system of FIG. 1;

FIG. 4 is a side view of the power-operated mechanism of FIG. 3,

FIG. 5A is a perspective view of an embodiment of a mounting bracket for use in mounting an electronic device to a forklift truck;

FIG. 5B is an enlarged portion of the FIG. 5A shown by phantom line;

FIG. 5C is a exploded view of a base plate, hangers, a pin, and a cover plate constructed to form mounting bracket in accordance to the present invention;

FIG. 5D illustrate the front side of the mounting plate;

Fig. D is the back side of the mounting plate;

Fig. F is one hanger attached to the bottom end of the mounting bracket shown in Fig. D;

Fig. G is another hanger attached to the top end of the mounting bracket shown in Fig. D;

Fig. H is a plan view of the hanger shown in Fig. G;

Fig. I is a plan view of the hanger shown in Fig. F;

Fig. J show a sectional view across line J-J depicted in FIG. 5B;

Fig. K illustrate a detail of a portion of Fig. J;

FIG. 6 is a side, section view of the power-operated mechanism along line 6-6 of FIG. 3;

FIG. 7 is a section view along line 7-7 of FIG. 6;

FIG. 8 is a back view of an embodiment of an opposing member for use in the power-operated mechanism of FIG. 3;

FIG. 9 is a top view of the power-operated mechanism of FIG. 3;

FIG. 10 is a front view of the power-operated mechanism of FIG. 3 in use;

FIG. 11 is a perspective view of an embodiment of a system and method for identifying inventory;

FIG. 12 is a diagrammatic view of an embodiment of a process of identifying inventory using the system of FIG. 1;

FIG. 13 is a diagrammatic view of an embodiment of a process of identifying inventory using the system of FIG. 11;

FIG. 14 is a diagrammatic view of an embodiment of a process of identifying inventory using the system of FIG. 1;

FIG. 15 is a diagrammatic view of an embodiment of another process of identifying inventory; and

FIG. 16 is a side view of an embodiment of an inventory handling device.

### DETAILED DESCRIPTION OF THE INVENTION

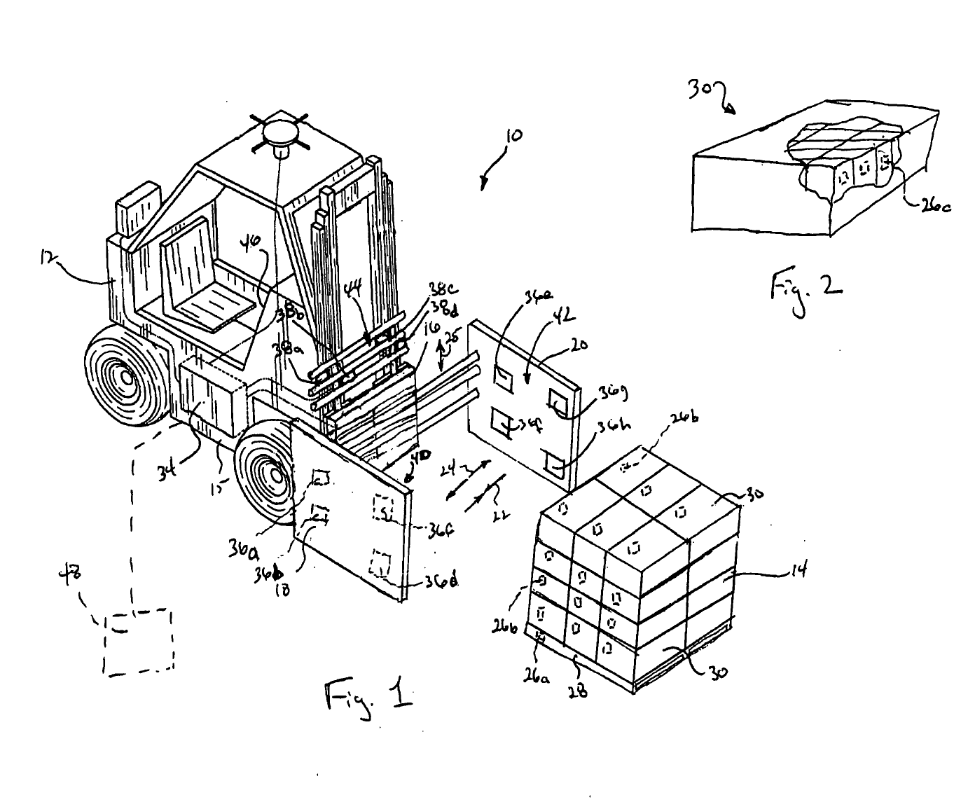

Referring to FIG. 1, a system 10 for handling and tracking inventory includes an inventory handling device, in this example, vehicle 12 and inventory unit 14. Vehicle 12 is movable, e.g., manually and/or automatically and includes a power-operated material handling mechanism 16 that can be used for moving the inventory unit 14 from one position to a different position during a material handling operation. In the illustrated embodiment, material handling mechanism 16 is a clamp having a first opposing member 18 and a second opposing member 20. The first and second members 18, 20 can move relative to a vehicle body 15, for example, to clamp the inventory unit 14. In some embodiments, the first and second members 18, 20 can move independently of each other. In other embodiments, movements of the first and second members 18, 20 are connected, for example, mechanically and/or electrically. In the illustrated example, the first and second members 18, 20 can move in a direction 22 toward each other (e.g., for a clamping operation) or in a direction 24 away from each other (e.g., for a releasing operation). The material handling mechanism 16 can also move up and down vertically in the direction of arrow 25.

System 10 includes automatic identification architecture for use in identifying and tracking inventory. While the description below focuses on radio frequency identification (RFID) technology, it should be understood that other technologies that facilitate automatic identification of items, locations, and/or other information whereby data is encoded, transmitted via an automatic identification object and can be read can be utilized.

Inventory unit 14 includes multiple automatic identification objects in the form of transponders at various locations throughout the inventory unit. As used herein, the term “transponder” refers to an electrical device that receives a specific signal and automatically transmits a reply. The reply typically includes identification information. In the illustrated embodiment, the transponders are RFID tags 26 represented by the dotted lines that include an integrated circuit connected (e.g., electrically coupled, either by direct contact or by capacitive coupling) to an antenna. The integrated circuit may include semiconductor circuits having logic, memory, RF circuitry, and may be a silicon-based chip, a polymer-based chip and the like. Data may be stored in the integrated circuit of the tags 26 (e.g., using EEPROM or SRAM, laser programming, etc.) and can be transmitted through the connected antenna.

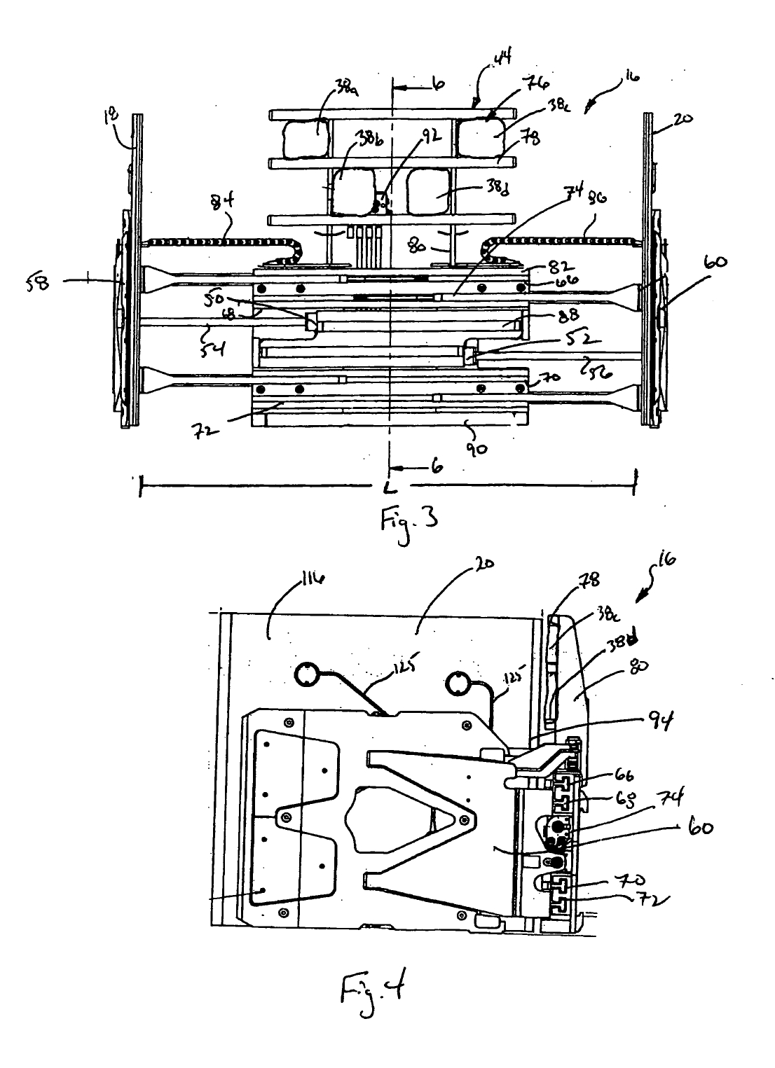

Tags 26 may be associated with various components of the inventory unit 14 and may contain data related to the associated component. Tag 26a is affixed to a pallet 28 and may contain, for example, pallet identification information for use in tracking the pallet 28. Tag 26a may also contain information associating the pallet 28 with the unit 14, cases 30 and/or items 32. Tags 26b are affixed to cases 30 and may contain, for example, case identification information for use in tracking the cases. Tags 26b may also contain information associating the cases 30 with the unit 14, items 32 and/or pallet 28. In some embodiments, tags 26c are affixed to items 32 and may contain, for example, item identification information for use in tracking the items (FIG. 2). Tags 26c may also contain information associating the items with the unit 14, cases 30 and/or pallet 28. Tags 26 may include information in addition to or other than that described above, such as location information, destination information, loading/unloading information, shipping information, timestamp information, etc.

The tags 26 may be affixed to components of the inventory unit using any suitable process. For example, a pressure sensitive adhesive, or other attachment medium, may be positioned on one side of the tags 26 for use in attaching the tag to a component. In some embodiments, the tags 26 may be applied using glues, hot melts, water activated adhesives, or other adhering mediums. The tags 26 may be applied with an automatic application device, such as a label applicator, which applies the tag to a surface of a component. In some embodiments, a tag 26 may be embedded in a label such as an adhesive-backed label. Such an arrangement may sometimes be referred to as a smart label, which may include a thin tag inlay (i.e., the integrated circuit, substrate and the antenna) embedded in a label which itself may be pre-printed and pre-coded, for example, with a barcode, text, graphics and the like.

In some embodiments, the identification information may include an electronic product code (EPC) that can be used to identify one or more inventory components (e.g., cases 30, pallet 28, etc.) of the inventory unit 14 and, in certain implementations, the inventory unit itself. In some instances, the tags 26 may allow the EPC (and other information stored therein) to be changed or added after the tags 26 are manufactured (i.e., the tags may be writable or rewritable as opposed to read-only). In some implementations, the tags 26 may hold tag manufacturing information such as a manufacturer identity. In some embodiments, the tags 26 may include certain features such as access control features and/or deactivation features and data such as codes associated with these features.

Depending on the application, various types of tags 26 may be used. Tags 26 are typically classified as active or passive. A passive tag has no internal power supply and receives power from an outside source. An active tag includes an internal power source. In some applications, passive tags may be preferred due to, e.g., relatively small size and low cost. In other applications, active tags may be preferred due to relatively long transmit ranges and large memories. Tags 26 may be read-only (i.e., stored data can be read but not changed), writable (i.e., data can be added), rewritable (i.e., data can be changed or re-written), or some combination of each. Suitable, commercially available passive tags 26 may include, for example, an AD-410 single dipole tag (Class 1) available from Avery Dennison, ALN-9340-R “Squiggle™” (Class 1) available from Alien Technology Corporation, Symbol Dual Dipole (Class 0) available from Symbol Technologies, and ALL-9334-02 “2×2” Tag (Class 1) available from Alien Technology Corporation.

System 10 utilizes vehicle 12 to electronically track inventory at a location or multiple locations in a supply chain. System 10 may be used to track inventory only within a discrete portion of a supply chain or, in some instances, system 10 may be used to track inventory as it moves throughout an entire supply chain. In some embodiments, system 10 may be used to track inventory within a single enterprise. In some embodiments, system 10 may be used to track inventory across multiple enterprises.

Vehicle 12 includes the first opposing member 18 and the second opposing member 20 that are used to engage the inventory unit 14 for use in moving the inventory unit from one location to a different location. While the inventory unit 14 may be moved using the vehicle 12 for a variety of purposes, in some instances, the inventory unit may be moved to or from a storage location within a warehouse, store or other facility, to or from a truck, plane, ship or train for transportation, etc., as examples.

The vehicle 12 includes a reader 34 (sometimes referred to as an interrogator) for use in activating and receiving data from the tags 26. The reader 34 may be controlled by a processor such as a microprocessor or digital signal processor and is carried by the vehicle 12. In some embodiments, the reader is mounted to the material handling mechanism 16. The reader 34 may be used to write data to or change data stored by the tag 26. Any suitable reader may be used. In some embodiments, reader 34 includes four receive channels and four transmit channels separate from the receive channels with about 1.8 watts of power per transmit channel. Power dividers may be used to enable connection of multiple transmit antenna per transmit channel. An exemplary reader 34 such as a Model 0101-0092-04 Sensormatic® EPC Reader is commercially available from Tyco International, Ltd or a Model “REAL” EPC Reader (MPR-3118, 3114 or 4114) is commercially available from Applied Wireless ID. Suitable power dividers include Model 50PD-232 SMA, commercially available from JFW Electronics and Model MP 8202-2, commercially available from S.M. Electronics, as examples.

Reader 34 communicates with tags 26 via a transmit antenna 36 and a receive antenna 38. In the illustrated embodiment, transmit antennae 36a-36h are disposed in opposing arrays 40, 42 with array 40 associated with first member 18 and array 42 associated with second member 20. Receive antennae 38a-38d are oriented in an array 44 that extends between and is substantially transverse to the opposing arrays 40 and 42 of transmit antennae 36a-36h. In some embodiments, the transmit antennae 36a-36h may be used by the reader 34 to perform both transmit and receive functions thereby eliminating the need for separate receive antennae 38a-38d.

Reader 34 may be capable of communicating with a computer, such as on-board computer 46. In some embodiments, reader 34 (and/or computer 46) may communicate with an off-board computer 48 (represented by dotted lines). Computer 46, 48 may further process or link information obtained using the tags 26 to another site, such as the Internet, for offsite monitoring. In some embodiments computer 46, 48 may be linked to a data management system, such as a warehouse management system, for example, that includes inventory component information in memory. Computer 46, 48 may provide instructions and/or information to be transmitted to the tags 26 through reader 34 and stored in the tags. In some embodiments, computer 46, 48 provides instructions and/or displays information to an operator based on information received from the tags 26. In embodiments including on-board computer 46, the computer 46 may provide instructions and/or display information to a user operating the vehicle 12. In some embodiments, computer 46 provides information to a warehouse management system which in turn based upon business logic or rules provides instructions and/or displays information to an operator based on information received from the tags 26 and/or location information.

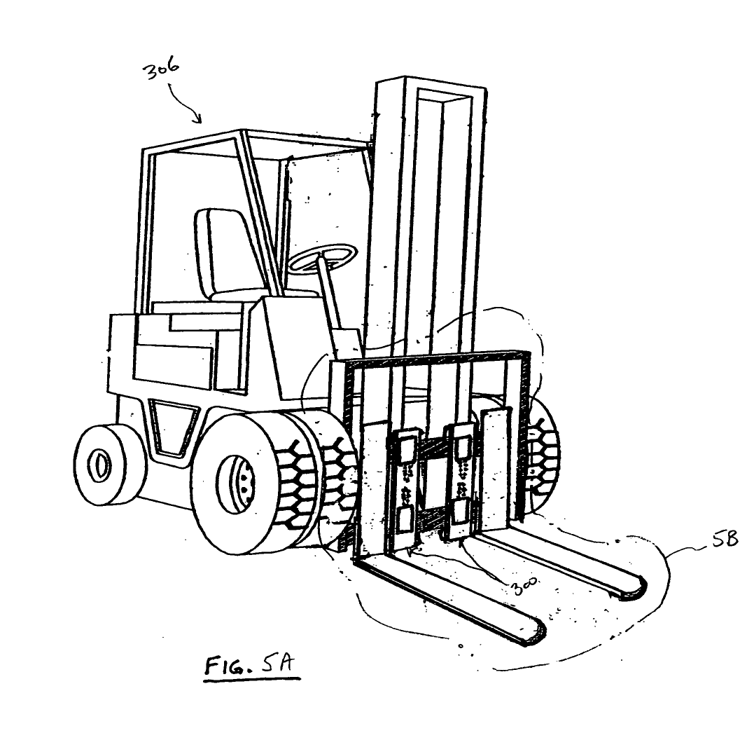

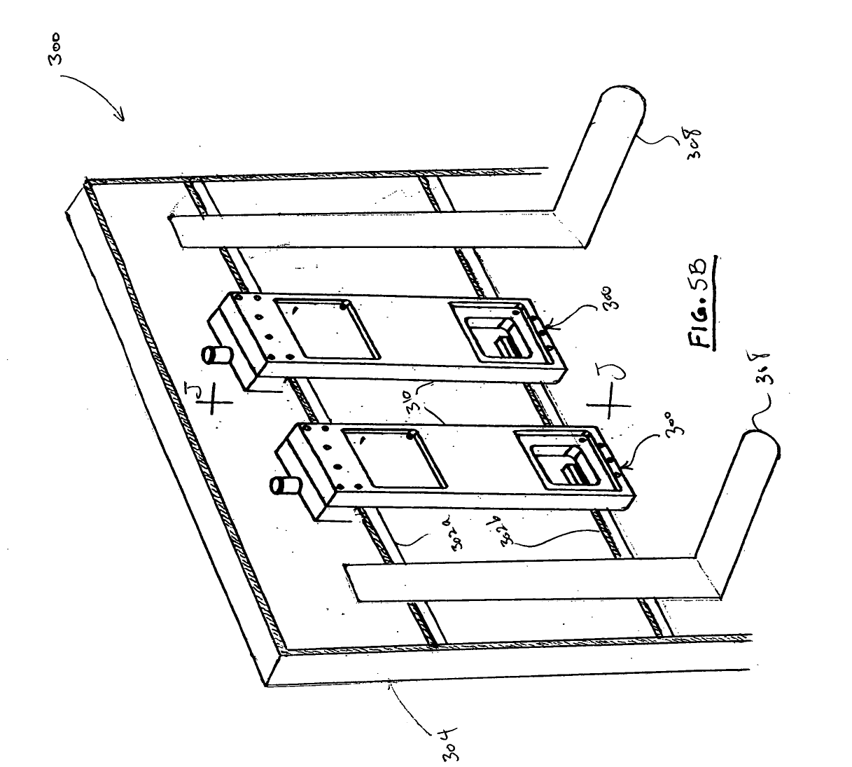

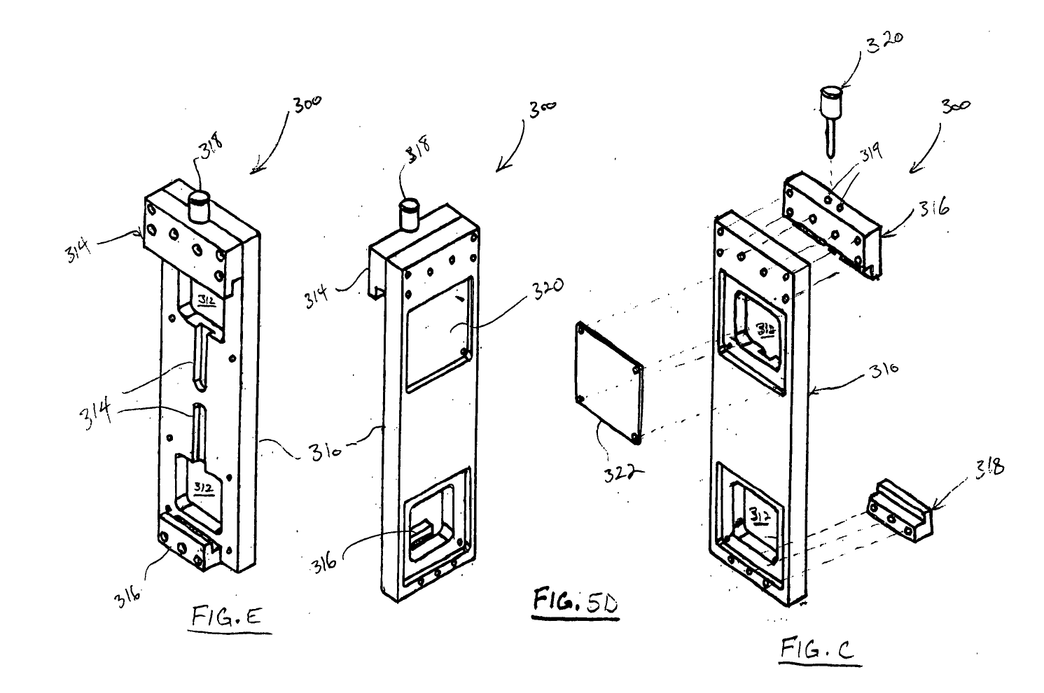

FIGS. 3 and 4 illustrate the power-operated mechanism 16 in isolation including the opposing first and second members 18, 20. Power-operated mechanism 16 is a clamp (e.g., having a capacity at 600 mm of about 1000 kg or more, such as about 1600 kg) capable of clamping an inventory unit 12 for moving the inventory unit. Power-operated mechanism 16 includes a backrest assembly 76 including horizontal members 78 supported by vertical members 80 on a front member 82 (e.g., formed of aluminum, such as Al 6061). Articulated cable carriers 84 and 86 house cable that connect the transmit antennae 36 (FIG. 5) to the reader 34 (FIG. 1). Upper and lower bumpers 88 and 90 are mounted to the front member 82 to inhibit damage to the power-operated mechanism 16 during use.

Receive antennae 38a-38d are mounted to the backrest assembly 76 to form the array 44. In some embodiments, receive antennae 38a-38d are mounted directly to the backrest assembly 76, for example, using fasteners. In some embodiments, referring to FIG. 5A, mounting brackets 300 are used to mount the receive antennae 38a-38d to the backrest assembly 76. The two Mounting brackets 300 are identical to one another and are mounted on a pair of rails 302a & 302b, which in turn, the pair of rails are attached to a frame 304. The frame 304 is mounted on a forklift truck 306. The forklift truck 306 includes a standard two forks 308 that appropriately spaced apart from one another. The mounting bracket 300 is mounted between the two forks 308 as clearly depicted in FIG. 5B.

Mounting bracket 300 includes a base plate 310 having two openings 312 therethrough that are shaped and sized to securely receive the receive antennae 38. As shown in FIG. 5E, the elongated recesses 314 extend from the two openings 312 and are sized to permit the openings to be in communication with a region exterior to the base plate 310. The elongated recesses 314 are disposed in the back side of the mounting bracket. For example, the elongated recesses 314 may receive connectors (not shown) extending from the receive antennae 38 to connect the receive antennae to the reader 34. Alternatively, the base plate 310 may have only one opening 312 or more than two openings therein, depend on the design and application that is used. The mounting bracket 300 includes hangers 316 and 318 connected to the base plate 310. The hangers 316 and 318 permit the mounting bracket 300 to be engaged with a stationary member. The stationary member can be a fork lift truck 306 or a frame 304, or alternatively, a wall bracket. The hangers 316 and 318 are used for adjustment of the mounting bracket position by using a pin 320. Two holes 319 are used for adjustment and securely attaching the mounting bracket to the stationary member such as rails 302a & 302b. The adjustment of hangers 316 and 318 permit for repositioning of the receive antennae 38 on the backrest assembly 76. Swivel mounting (not shown) can be incorporated to allow for adjustment of the receive antennae 38 angles up, down and/or side-to-side within the openings 312. The mounting bracket 300 can also be lengthened horizontally and/or vertically to accommodate more receive antennae 38. Suitable materials for use in forming the mounting bracket 300 include steel, aluminum, or a durable polymer such as nylon. Since forklift trucks are notorious for inflicting and sustaining damage, and thus, the electronic components and connections should be covered or otherwise protected. Therefore, a cover plate 322 is shaped and sized to enclose the opening 312 as depicted in FIG. 5D.

FIGS. 5G-5I are illustrating the two hangers 316 and 318. There are six holes 324 shown on hangers 316 which are used to attach the hanger 316 to the base plate 310 by inserting a sized bolt in each of the holes therein. The bolt holes 324 are extended through the depth of the hanger 316. Holes 319 are extended through the width of the hanger 316 and as described above, are used to securely fasten the mounting bracket 300 to the stationary member such as rails 302a & b. Similarly, there are three bolt holes 326 that are used to attach the hanger 318 to the base plate 310. The bolt holes 326 are extended through the width of the hanger 318.

FIGS. 5J and 5k illustrate the manner in which the hangers 316 and 318 are mounted on the rails 312a and 312b. the hangers and rails are sized such that there is clearance 328 between the hangers and the rails so that the mounting bracket 310 can be adjusted on the rail and securely fasten to the rails.

Referring again to FIGS. 3 and 4, first and second members 18, 20 can be actuated by any suitable device such as pneumatic, linear or hydraulic actuators 50 and 52 having pistons 54 and 56 that are connected to the respective first and second members at their respective truck-side edges 94. Arms 58 and 60 are connected to the first and second members 18, 20 for additional support and guidance and are received in tracks 66, 68, 70, 72 formed in front member 74. A control valve 92 may be included for controlling the actuators 50, 52 individually and/or concurrently. The opposing first and second members 18, 20, in some embodiments, provide an open operating range L of about 2 m or less, such as between about 0.5 m and about 2 m.

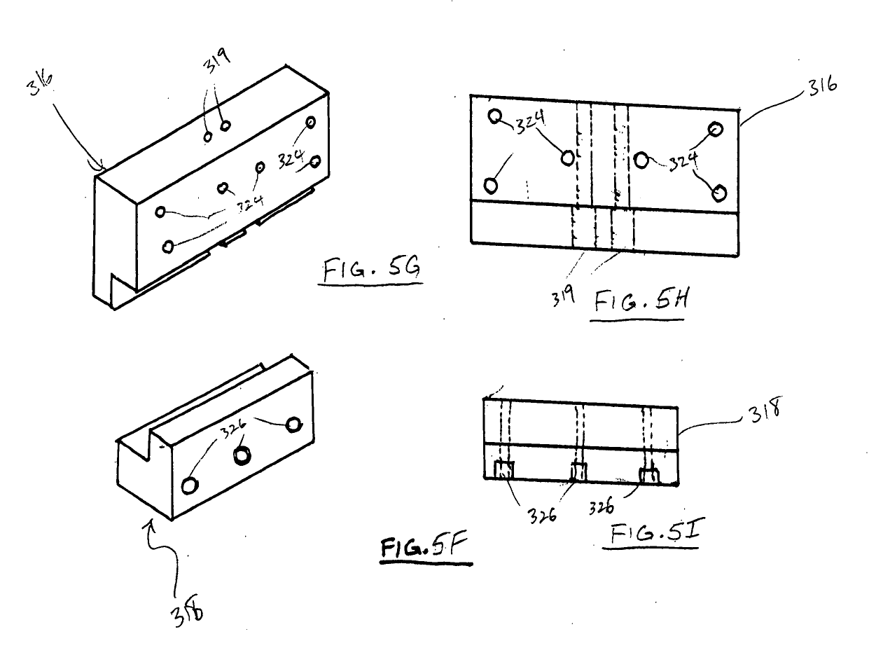

Referring to FIG. 6, the transmit antennae 36a-36h are arranged in respective arrays and/or pattern 40, 42 on their respective first and second member 18, 20 to maximize the collective transmission coverage surface area and/or unit volume of the arrays 40, 42. While dimensions of only first member 18 will be described as an exemplary embodiment, it should be understood that second member 20 may be substantially the mirror image of the first member. Additionally, other dimensions and transmit antennae placements are possible, e.g., to achieve maximum RFID read performance to account for variation in unit load packaging, unit material, unit load dimensions, unit load stack patterns, member 18, 20 dimensions, etc. For example, while a 2×2 array is depicted, other arrangements may be used depending the desired use and requirements such as a 1×3 array, a 3×1 array, a 3×2 array and the like.

First member 18 has a relatively planar contact surface 96 having a height H (e.g., of between about 80 cm and about 160 cm, such as about 120 cm) and a width W (e.g., of between about 80 cm and about 160 cm, such as about 120 cm). In some embodiments, H and W are substantially identical. Transmit antennae 36a-36d each, in certain embodiments, form a portion of the contact surface 96 and include an outside edge 98, an inside edge 106, an upper edge 108, a lower edge 110, a height H′ (e.g., of between about 8 cm and about 20 cm, such as about 15 cm) and a width W′ (e.g., of between about 8 cm and about 20 cm, such as about 15 cm). In some embodiments, H′ and W′ are substantially identical. Outside edges 98 of transmit antennae 36a and 36b have a longitudinal distance d₁ of between about 20 cm and about 60 cm, such as about 42 cm from the truck-side edge 94. In some embodiments, such as the one illustrated, the outside edges 98 of the transmit antennae 38a and 38b are offset horizontally from each other (e.g., by between about 8 cm and about 15 cm, such as about 10 cm). Upper edge 108 of transmit antenna 36a has a vertical height h₁ of between about 60 cm and about 110 cm, such as about 100 cm from a bottom edge 112 of the face 96. Lower edge 110 of transmit antenna 36b has a height h₂ of between about 10 cm and about 40 cm, such as about 25 cm from bottom edge 112. Inside edges 106 of transmit antennae 36c and 36d have a longitudinal distance d₂ of between about 70 cm and about 100 cm, such as about 90 cm from truck-side edge 94. In some embodiments, such as the one illustrated, the inside edges 106 of the transmit antennae 38c and 38d are offset horizontally from each other (e.g., by between about 8 cm and about 15 cm, such as about 10 cm). Upper edge 108 of transmit antenna 36c has a vertical height h₃ of between about 60 cm and about 110 cm, such as about 105 cm from bottom edge 112. Lower edge 110 of transmit antenna 36d has a vertical height h₄ of between about 10 cm and about 40 cm, such as about 20 cm from bottom edge 112.

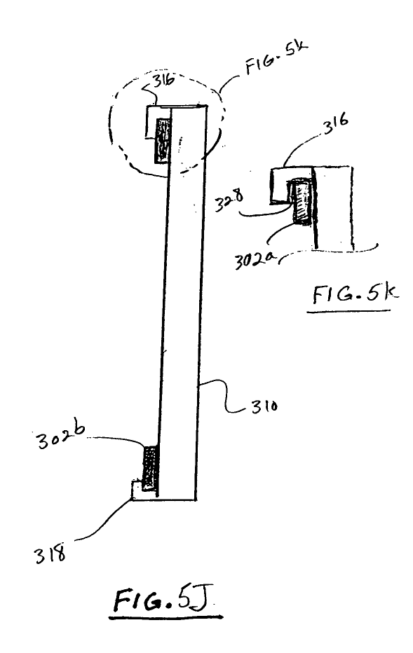

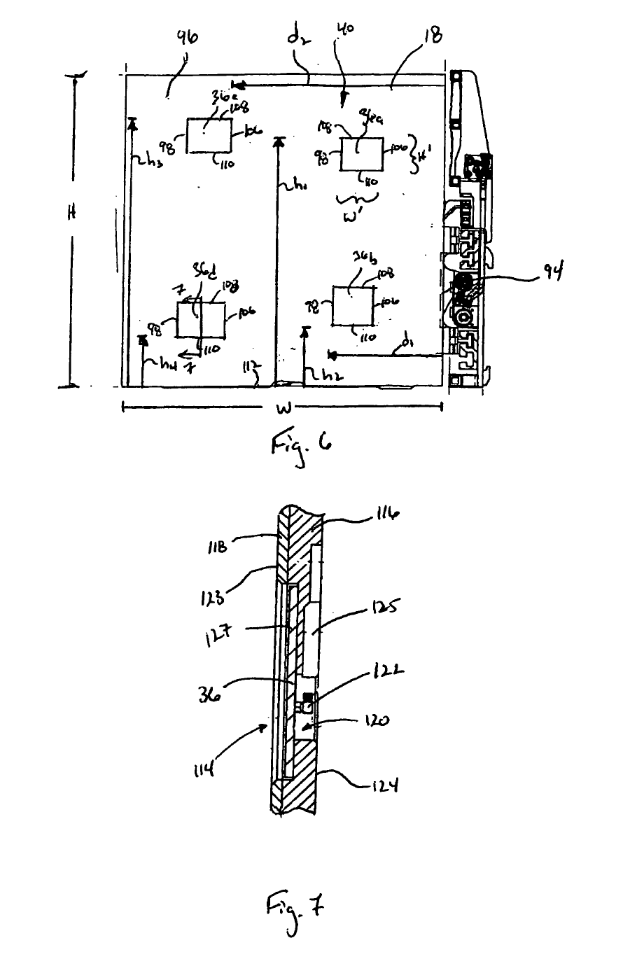

Referring now to FIG. 7, the transmit antennae 36 are located in a recess 114 formed in plate 116 (e.g., formed of aluminum, such as Al 6061). Adjacent plate 116 is contact pad 118 (e.g., formed of rubber (natural, synthetic or hybrid), polymer, neoprene, etc.). Pad 118 provides an outer surface 123 having a relatively high coefficient of friction (e.g., to aid in gripping the inventory unit) and conformation to the inventory unit, for example, to reduce damage. While the transmit antennae 36 are shown recessed from surface 123 of contact pad 118, in some instances, transmit antennae may be substantially flush with surface 123 to allow the transmit antennae 36 to contact the inventory unit 14 during a moving operation. In some embodiments, transmit antennae 36 are recessed from surface 123 (e.g., a distance of about 6 mm or more, such as about 9 mm or more, such as between about 6 mm and about 10 mm) so that the transmit antennae 36 do not contact the inventory unit. In these embodiments, the transmit antennae 36 may be tuned for transmission through air. In an alternative embodiment, transmit antennae 36 are recessed from surface 123 (e.g., a distance of about 6 mm or less, such as about 5 mm or less, such as between about 0.5 mm and about 5 mm) so that an outer surface of the transmit antennae 36 contact the inventory unit. In these embodiments, the transmit antennae 36 may be tuned for transmission through material forming the inventory unit. Additionally, an outer casing 127 of the antennae 36 may be formed using a material (e.g., microwave Teflon-glass material with or without laminate overlay) selected to withstand clamping loads applied against the antennae. Referring also to FIG. 8, an opening 120 extends through the plate 116 and is sized to receive a connector 122 of the transmit antenna 36 for connection with reader 34. A cable recess 125 is formed in a back surface 124 of the plate 116 for receiving cable and for providing a cable pathway between the plate 116 and arms 60, 62 (FIG. 4).

In some embodiments, RF matching of the antennae 36 (e.g., transmit and/or receive) to the interface medium (e.g., air and/or inventory unit) and/or antennae 36 recession depth within recess 114 provides maximum RFID unit load read performance. RFID unit read performance is affected by the dielectric constant on the interface medium; therefore, the antennae 36 should be tuned accordingly. In instances where RFID performance requires penetrating the inventory unit, the distance that the transmit antennae 36 are recessed from surface 123 may be considered when optimizing RF read performance. For example, in the case of picking paper rolls having an embedded RFID tag, the RF specifications (see, e.g., Example I below) and the recessed surface 123 may be specified to ensure direct contact between the antennae 36 and the paper roll without exerting excessive (i.e., damaging) compression forces on the antennae. In other instances where RFID performance requires surface radiation to achieve optimized RF read performance, the RF specifications (see, e.g., Example II below) and the distance that transmit antennae 36 are recessed from surface 123 is specified to ensure a gap between the inventory unit and the antennae surface throughout the entire clamping operation.

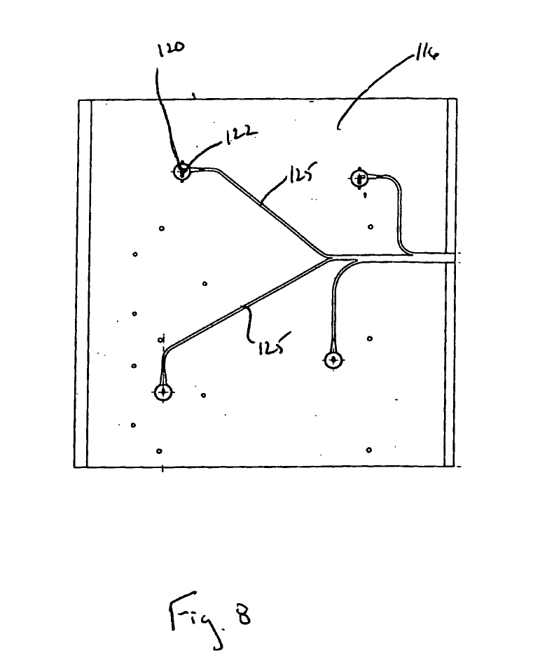

Referring to FIG. 9, as can be appreciated from the foregoing description, the transmit antennae arrays 40 and 42 may be arranged in substantially planar arrays (the planes being represented by dotted lines 126 and 128), the planes 126, 128 being substantially parallel to each other. Receive antennae array 44 may also be arranged in a substantially planar array (the plane being represented by dotted line 130), the plane 130 intersecting planes 126, 128 at an intersect angle θ. Preferably, θ is between about 45 and 135 degrees, such as about 90 degrees to minimize interference between the arrays 40, 42 and 44 during operation.

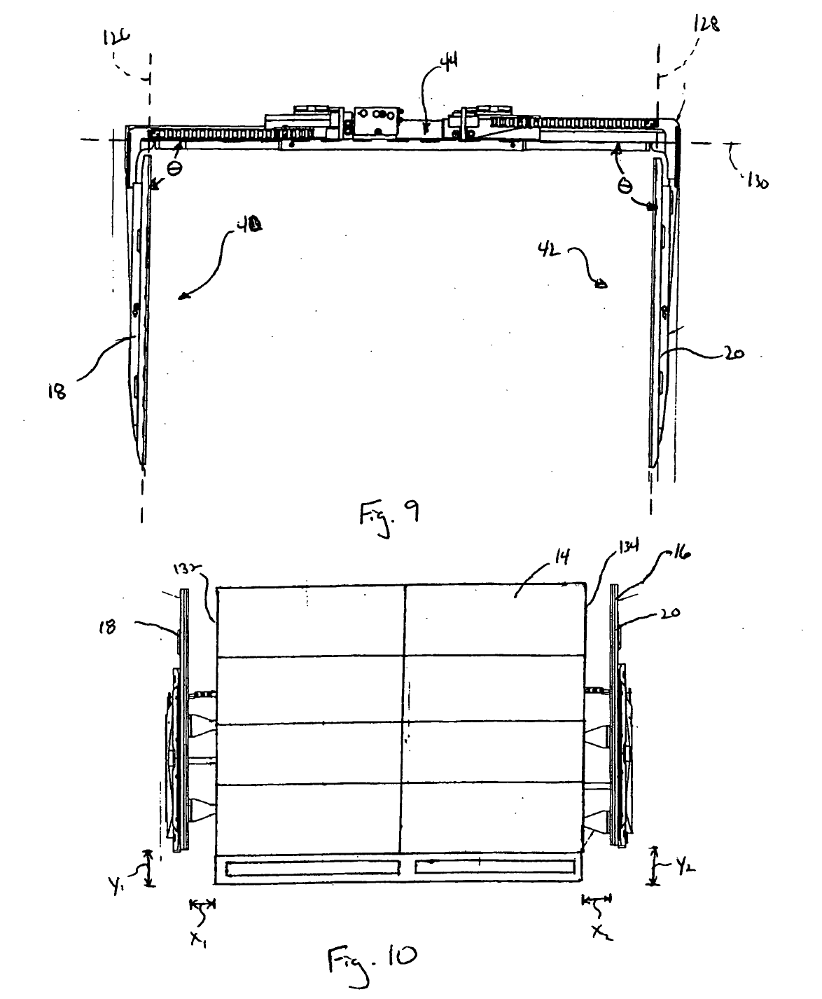

FIG. 10 shows power-operated mechanism 16 in a read position with the first and second members 18, 20 adjacent opposite sides 132, 134 of inventory unit 14. In some embodiments, the above-described system architecture can provide a given read accuracy, for example, a 100 percent tag read accuracy. For example, for a given inventory unit tag distribution (e.g., of case tags, item tags, pallet tags, etc.) of, e.g., 24 total tags, 36 total tags, 100 total tags, etc., it may be preferred that the correct identification data (e.g., the EPC) is collected from 100 percent of the tags during a single read operation of a given time period. As is known in the art, however, many factors can affect read accuracy like environmental factors such as humidity and the composition of the inventory unit itself. For example, certain liquids, metals, etc. may affect the read accuracy.

Additionally, it may be desirable that the given read accuracy be achieved within a given positional tolerance range. As shown by FIG. 10, the first and second members 18, 20 are positioned laterally respective distances x₁ and x₂ from sides 134, 134 and vertically respective distances y₁ and y₂ from base 136. In some embodiments, the above-described system architecture can achieve the given read accuracy for a range of x₁, x₂, y₁ and y₂ such as about 50 cm or less. This can improve operational efficiency by reducing the time necessary to precisely position the first and second members 18, 20 to achieve the given read accuracy. However, in use, a large positional tolerance range may result in inadvertent reads, for example, from nearby tags of adjacent inventory units.

### TRANSMIT/RECEIVE ANTENNA EXAMPLES

Exemplary transmit/receive antenna specifications are provided below. A suitable manufacturer for producing each antenna example is Symbol Technologies, Inc. These examples are not intended to be limiting as other antenna examples may be utilized.

### EXAMPLE I

Length (L′)=4 inches (10 cm)

Width (W′)=3.8 inches (9.5 cm)

Probe to Edge Distance=0.9 inches (2 cm)

Dk (εᵣ)=2.2

Substrate Thickness=250 mils (0.6 cm)

Polarization=Linear (Vertical)

Resonant Freq.=935 MHz

Bandwidth=3.2%

Gain (dBi)=5.4

E-plane—3 dB Beamwidth—103.3 degrees

H-plane—3 dB Beamwidth—81.8 degrees

### EXAMPLE II

Length (L′)=4.1 inches (10 cm)

Width (W′)=3.8 inches (9.5 cm)

Probe to Edge Distance=0.9 inches (2 cm)

Dk (εᵣ)=2.2

Substrate Thickness=250 mils (0.6 cm)

Polarization=Linear (Vertical)

Resonant Freq.=914 MHz

Bandwidth=3.1%

Gain (dBi)=5.4

E-plane—3 dB Beamwidth—104 degrees

H-plane—3 dB Beamwidth—80 degrees

### EXAMPLE III

Length (L′)=4.05 inches (10 cm)

Width (W′)=3.98 inches (9.5 cm)

Probe to Edge Distance=0.86 inches (2 cm)

Dk (εᵣ)=2.2

Substrate Thickness=250 mils (0.6 cm)

Polarization=RHCP or LHCP

Resonant Freq.=915 MHz

Bandwidth=2.8%

Gain (dBi)=5.4

Axial Ratio=2 dB at center and about 4 dB at the band edges

In some embodiments, a read operation may be triggered based upon the occurrence of a selected event. The event may be sensed, for example, using a sensor that senses an event related to movement of the mechanism 16 and sends a signal to a controller (e.g., computer 46). In some embodiments, the controller may further include a triggering algorithm that is used to operate the reader 34. In one embodiment, the reader 34 may be activated to obtain tag reads upon detection of an initial pressure increase in actuators 50, 52 via a pressure transducer and remain activated throughout mechanism 16 movement, for example, until the actuators 50, 52 reach a final pickup pressure threshold. In another embodiment, reader 34 may be activated to obtain product reads upon detection of mechanism 16 movement, for example, using a photo-eye, limit switch, etc. The reader 34 may remain activated through movement of the members 18, 20 and deactivate once the sensor determined that the members 18, 20 reach a predetermined position. As another example, the reader 34 may be activated once the actuators 50, 52 reach a final pickup pressure and remain activated for a preselected time period or the reader 34 may be activated upon detection of mechanism 16 movement, for example, using a photo-eye, limit switch, etc. and deactivate after a preselected time period has lapsed. In another embodiment, the reader 34 may be activated based upon detection of mechanism 16 movement, for example, using a photo-eye, limit switch, etc. and remain activated until a final pickup pressure threshold is sensed, for example, using a pressure transducer.

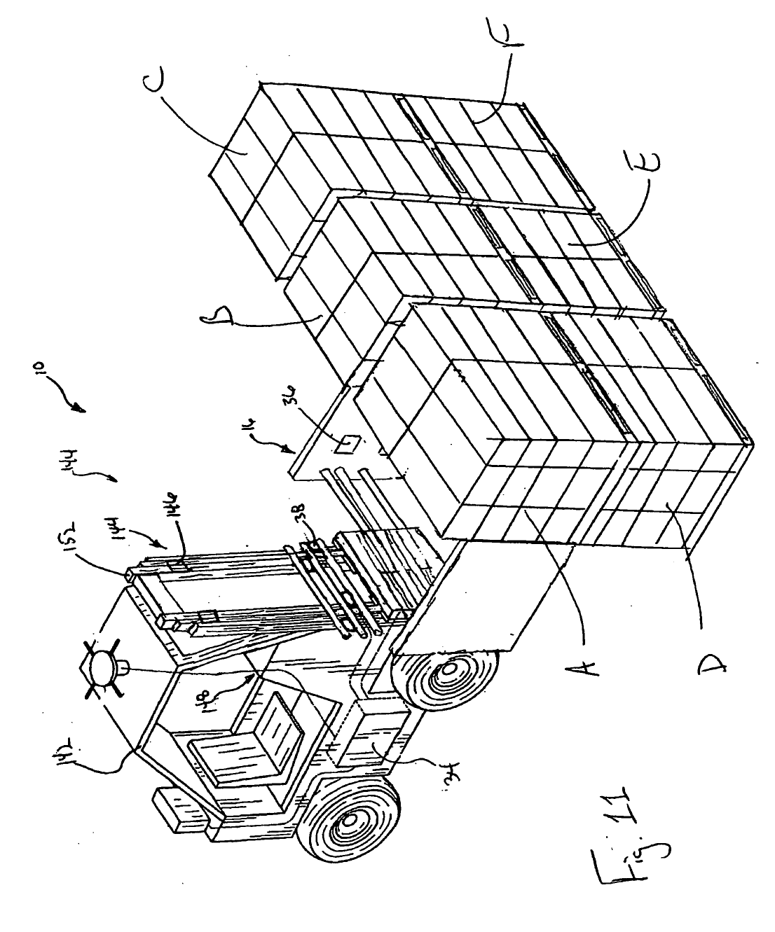

System 10 of FIG. 11 further includes an automatic inventory unit identification feature. In the illustrated embodiment, system 10 includes a vehicle 142 having features of vehicle 12 including the power-operated mechanism 16, reader 34, transmit antennae 36 and receive antennae 38 and further includes a locating system 144 that includes a forward-facing antenna 146 and an associated reader 148. Antenna 146 is fixedly mounted to mast 152. In alternative embodiments, antenna 146 is mounted to a moveable (e.g., vertically) portion of the power operated mechanism 16. In some embodiments, reader 148 may include the antenna 146. In some embodiments, the antenna 146 may communicate with reader 34. The reader 148 may be capable of both initiating and reading tag transmissions via antenna 146. Suitable reader/antenna examples include Model 0101-0092-04 Sensormatic® EPC Reader, commercially available from Tyco International, Ltd. or a Model “REAL” EPC Reader (MPR-3118, 3114 or 4114), commercially available from Applied Wireless ID, or any other commercially available reader/antenna arrangement that meets the electrical requirements of the system and is capable of interrogating tags 26.

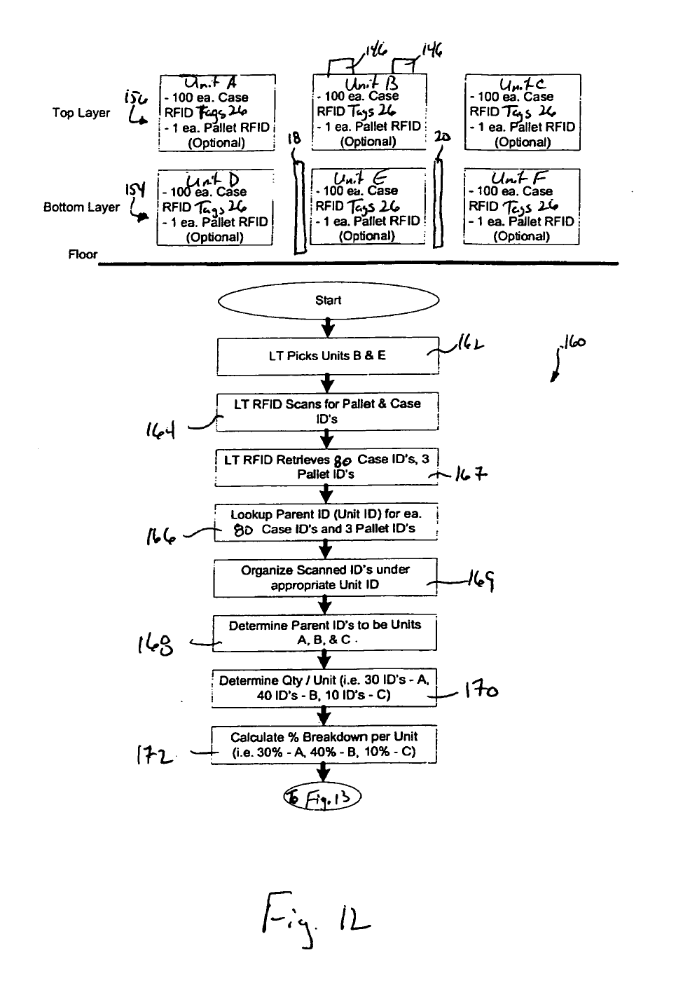

System 10 can automatically identify a target inventory unit from multiple inventory units by polling a tag 26 population associated with the multiple inventory units, such as inventory units A-F of FIG. 11. Referring to FIG. 12, inventory units A-F are schematically represented with inventory units D-F forming a bottom layer 154 and inventory units A-C forming a top layer 156 stacked upon bottom layer. As an example, each inventory unit A-F includes 100 case RFID tags 26 associated with respective cases and one pallet RFID tag 26 associated with the pallet. Also represented by FIG. 12 is a diagram illustrating a process 160 for identifying a target inventory unit. Process 160 may be implemented using any suitable system, such as through use of computer software, as an example.

At step 162, for example, inventory units B and E are selected or targeted for a moving operation. Inventory unit E can be identified by positioning the first and second members 18 and 20 of vehicle (LT) 142 adjacent inventory unit E as described above with reference to FIG. 10 and the associated description. Reader 34 interrogates the tags 26 of inventory unit E using the antennae 36 and 38 and reads case and, in some instances, pallet identifying information transmitted by the activated tags 26. The case and pallet information retrieved from the tags 26 can be compared to information saved in memory of an inventory management system (IMS) having inventory unit and case and pallet identification information stored therein to verify that the inventory unit is, in fact, inventory unit E.

At step 164, reader 148 interrogates tags 26 using antennae 146. Due to the positions of antennae 146, case identification information from 80 case tags 26 and pallet identification information from 3 pallet tags 26 are retrieved at step 167. Of course, the number of case and pallet tags read during step 164 may vary from reading to reading.

At step 166, the case identification information and the pallet identification information retrieved at step 167 is compared to information stored in the IMS to determine their associated inventory unit or parent and the information is organized under the appropriate unit ID at step 169. In this example, it is determined that the case and pallet identification information retrieved is a component or child of either inventory unit A, B or C at step 168. In particular, at step 170 it is recognized using information stored in the IMS that 30 retrieved case identifiers (e.g., EPCs) are associated with inventory unit A, 40 case identifiers (e.g., EPCs) are associated with inventory unit B and 10 case identifiers (e.g., EPCs) are associated with inventory unit C. At a processing step 172, knowing the number of tags 26 per inventory unit A-C from the information stored in the IMS (in this example 100 tags 26 per inventory unit), it is determined that 30 percent of the case identifiers of inventory unit A are retrieved, 40 percent of the case identifiers of inventory unit B are retrieved and 10 percent of the cases of inventory unit C are retrieved.

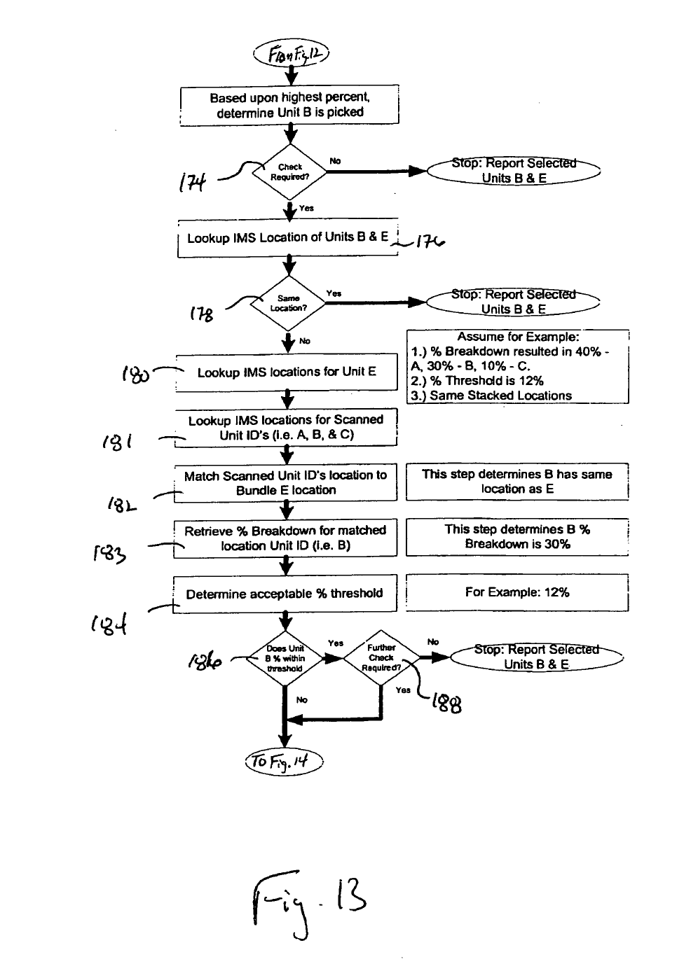

Referring to FIG. 13, due to the position of antenna 146 at inventory unit B, it may be determined based solely on the percentages calculated at step 172 (and/or the number of case identifiers retrieved from each inventory unit A-C at step 170) that inventory unit B is, in fact, the target inventory unit and is in position to be picked using vehicle 142. However, it may be desirable to provide a check 174 to increase the probability that inventory unit B is, in fact, in position to be picked by the vehicle 142. Check 174 may be desirable because the number of tags read for steps 170 and 172 may be affected by a variety of factors, such as tag 26 location, tag population per inventory unit, environmental conditions, content of the inventory units, etc.

To illustrate, assume at step 172 it is determined that 40 percent of the case identifiers of inventory unit A are retrieved, 30 percent of case identifiers of inventory unit B are retrieved and 10 percent of case identifiers of inventory unit C are retrieved. If no check 174 is required, it would be determined that vehicle 142 is not properly positioned to pick inventory unit B because a higher percentage of tags 26 of inventory unit A are retrieved. With check 174 required at step 176, location information of inventory units B and E are retrieved from the IMS. At step 178, if the location information indicates that inventory units B and E are at the same location on the floor then it is determined that inventory units B and E are located for picking. If the location information indicates that inventory units B and E are not at the same location, at steps 180 and 181 location information is retrieved from the IMS for each scanned inventory unit, in this example, inventory units A, B, C and E. At step 182, the location information for inventory units A, B and C is matched to the location of inventory unit E, which determines that inventory unit B has the same location as inventory unit E. At step 183, the percentage of case identifiers from inventory unit B calculated at step 172 is retrieved, in this instance, 30 percent. At step 184, an acceptable threshold percentage is determined (e.g., 12 percent). The percentage of case identifiers of inventory unit B is compared to the highest retrieve percentage, in this instance, from inventory unit A at step 186 to determine whether the difference between the percentages falls within the threshold percentage determined at step 184. In this example, because the difference between the retrieve percentage of inventory unit A and B falls within the threshold percentage, it is determined that inventory unit B is in position to be picked. In some embodiments, another check 188 is utilized even if the difference between the retrieve percentage of inventory unit A and B falls within the threshold percentage. In some embodiments, the system may prompt for manual intervention if the difference between the retrieve percentage of inventory unit A and B falls outside the threshold percentage.

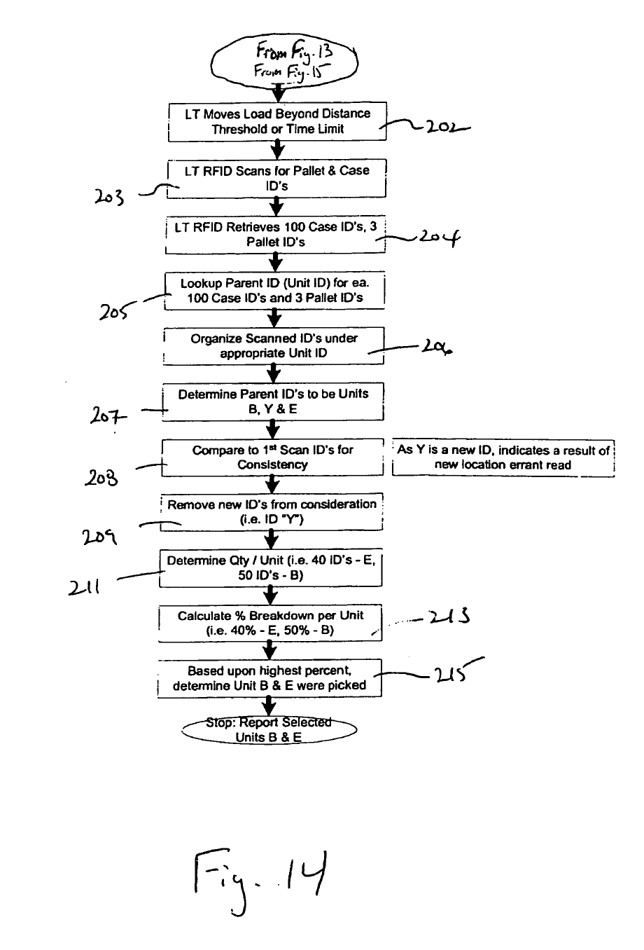

Referring to FIG. 14, to perform another check, the power-operated mechanism 16 including members 18 and 20 of vehicle 142 may be used to reposition inventory units B and E where another reading is performed to determine whether inventory units B and E have, in fact, been selected. At step 202, vehicle 142 moves inventory units A and E a preselected distance or for a preselected time period and, at step 203, another reading is performed utilizing the antennae 146. At step 204, case identification information from 100 case tags 26 and 3 pallet tags 26 are retrieved and, at step 205, the case identification information and the pallet identification information retrieved at step 204 is compared to information stored in the IMS to determine their associated inventory unit or parent and the information is organized under the appropriate unit ID at step 206. In this example, it is determined that the case and pallet identification information retrieved is a component or child of either inventory unit B, Y and E at step 207. At step 208, reading results are compared to reading results from step 168, which determines that all identification information organized under unit Y are errant as unit Y is an inventory unit not identified at step 168. At step 209, all case and pallet information organized under inventory unit Y are removed from consideration and, at step 211, quantity of cases identified is determined to be 40 cases of inventory unit E and 50 cases of inventory unit B. At step 213, knowing the number of tags 26 per inventory unit B and E from the information stored in the IMS (in this example 100 tags 26 per inventory unit), it is determined that 40 percent of the case identifiers of inventory unit E are retrieved and 50 percent of the case identifiers of inventory unit B are retrieved. Based upon the retrieve percentages calculated, it may be determined that inventory units B and E are selected at step 215. However, if a total retrieve percentage is relatively low (e.g. less than 50 percent), it may be determined that at least one of the target inventory units is not selected. In this instance, the system may prompt for manual intervention.

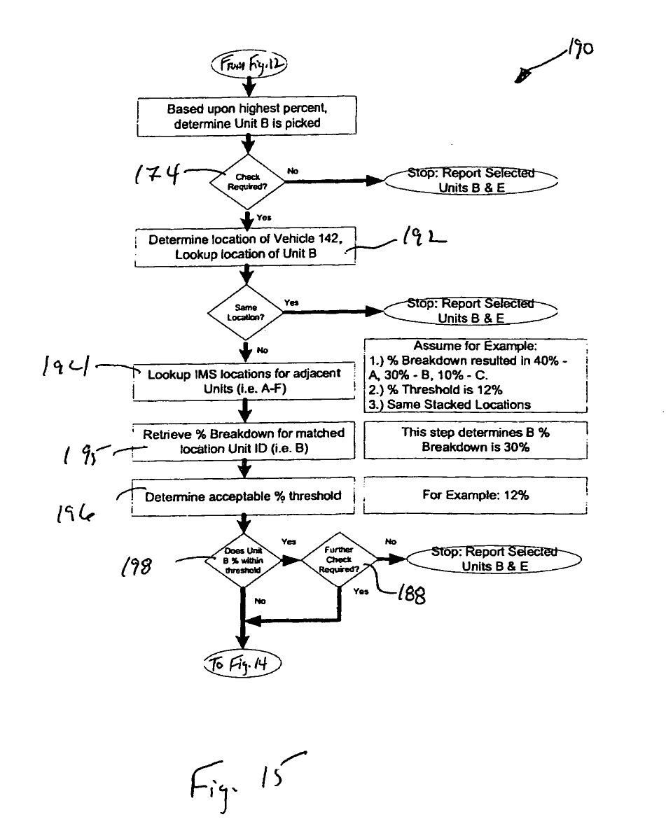

FIG. 15 shows an alternative embodiment 190 where location of a scanned inventory unit is compared to vehicle 142 position information rather than to location information associated with a reference inventory unit in performing check 174. In some embodiments, method 190 can be utilized to determine whether vehicle 142 is positioned to pick a target inventory unit without use of antennae arrays 40, 42 and 44 described above.

At step 192, location of vehicle 142 is determined and location information for inventory unit B is retrieved from the IMS. If the location information indicates that inventory unit B is in position for a picking operation based on location information determined for the vehicle 142, then it is determined that inventory unit B has been properly selected. If the location information indicates that inventory unit B is not in position for a picking operation based on location information determined for the vehicle 142, at step 194 the vehicle location information is used to identify nearby inventory units, in this instance, inventory units A-F, for example, within pre-selected zones adjacent the determined vehicle location from information stored in the IMS. The percentage of case identifiers from inventory unit B calculated at step 172 is retrieved at step 195, in this instance, 30 percent. At step 196, an acceptable threshold percentage is determined (e.g., 12 percent). The percentage of case identifiers of inventory unit B is compared to the highest retrieve percentage, in this instance, from inventory unit A at step 198 to determine whether the difference between the percentages falls within the threshold percentage determined at step 196. In this example, because the difference between the retrieve percentages falls within the threshold percentage, it is determined that vehicle 142 is in position to pick inventory unit B. Otherwise, the system may prompt for manual intervention at step 200.

As an alternative to utilizing the percentages calculated at step 172 to determine the acceptable threshold at steps 184 and 196, the threshold may be based on the number of case identifiers retrieved per inventory unit. For example, if the difference between the number of case identifiers retrieved for inventory units A and B is less than the acceptable threshold number, for example, 12, then it may be determined that the vehicle 142 is in position to pick inventory unit B.

Any suitable method and system known in the art can be used to determine vehicle position. One suitable system and method is described in pending U.S. patent application Ser. No. 10/305,525, filed Nov. 26, 2002, entitled “System and Method for Tracking Inventory”, the content of which is hereby incorporated by reference as if fully set forth herein. Other suitable systems and methods include, for example, use of fixed markers, such as RFID tags mounted at fixed positions, position sensors, magnetic tape, triangulating methods, for example, utilizing 80211 technology, non-triangulating systems, etc.

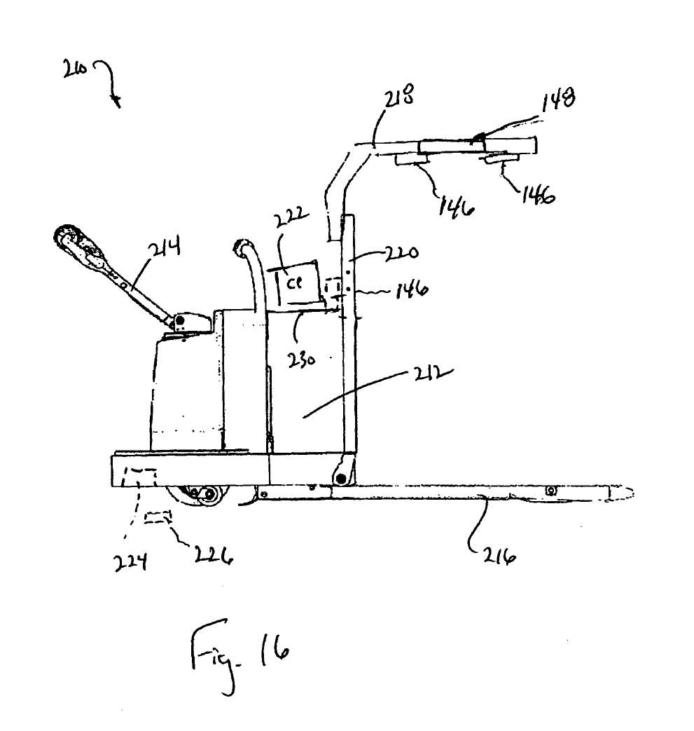

Steps described above with reference to FIG. 15 may be utilized to select an inventory unit from a group of inventory units that form a single row (i.e., from a group of unstacked inventory units). In some embodiments, an inventory handling device including antennae 146 may be utilized to select an inventory unit without use of antennae arrays 40, 42 and/or 44 described above. Referring to FIG. 16, inventory handling device 210 (sometimes referred to as a walkie) includes a body 212, a handle 214 for use in controlling the device 210, and forks 216 for use in transporting an inventory unit. An exemplary walkie is a Yale Electric Model MPE-080-E, commercially available from Yale Materials Handling Corporation.

An overhang 218 is mounted to a mast 220 and overhangs the forks 216. Connected to the overhang 218 are antennae 146 and reader 148. Reader 148 can interrogate and read tags 26 via the antennae 146. In some embodiments, antennae may be mounted to the device 210 using a mounting bracket, such as bracket 100 illustrated by FIG. 5. In other embodiments, the antennae 146 may be mounted directly to the device 210 or, as shown by the dotted lines, the antenna 146 may be carried on shelf 230. In certain embodiments, the antennae 146 may be mounted directly to the mast 220 as opposed to an overhang 218. Reader 148 is connected to an on-board computer 222 carried on shelf 230, which can be used to process information received by the reader.

In some embodiments, the device 210 may utilize a vehicle position tracking system to determine position of the device. While the device 210 may utilize a position tracking system described above, device 210 includes an antenna 224 that is mounted to read floor RFID tags 226 embedded or located on the floor. The tags 226 transmit position information that can be read and processed by the computer 222 to determine position of the device 210.

The systems and methods described above provide a number of benefits in real time, including the ability to track the location of inventory, improve warehouse utilization, improve the placement of inventory, provide independent shipment verification, and provide an electronic physical inventory. The systems and method may be used to identify and track a variety of inventoried products for a variety of industries.

While various features of the claimed invention are presented above, it should be understood that the features may be used singly or in any combination thereof. Therefore, the claimed invention is not to be limited to only the specific embodiments depicted herein.

Further, it should be understood that variations and modifications may occur to those skilled in the art to which the claimed invention pertains. The embodiments described herein are examples of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

What is claimed is:

1. A mounting bracket for positioning an electronic device relative to a stationary member comprising:
a base plate having at least one opening therethrough wherein the opening receives an electronic device therein, an elongated recess extending from the opening of the base plate, the elongated recess permits the opening to be in communication with a region exterior to the base plate; and
at least one hanger connected to the base plate, the hanger being configured to engage with the stationary member.

2. The mounting bracket of claim 1 wherein the mounting bracket is adjustable with respect to the stationary member.

3. The mounting bracket of claim 1 wherein the mounting bracket is fixedly attached to the stationary member.

4. The mounting bracket of claim 1 wherein the stationary member is a frame.

5. The mounting bracket of claim 1 wherein the stationary member is a forklift truck.

6. The mounting bracket of claim 1 wherein the stationary member is a wall rail.

7. The mounting bracket of claim 1 wherein the base plate includes a front surface and a back surface wherein the elongated recess located in the back surface of the base plate.

8. The mounting bracket of claim 1 further comprising a cover plate attached on the front surface of the mounting bracket.

9. The mounting bracket of claim 1 wherein the hanger is detachably connected at one end of the base plate.

10. The mounting bracket of claim 1 wherein the electronic device is a RFID antenna.

11. A mounting bracket for positioning an electronic device relative to a stationary member comprising:
a base plate having a plurality of openings therethrough wherein at least one of the plurality of openings receives an electronic device therein, at least one of the plurality of openings includes an elongated recess extending from the opening of the base plate, the elongated recess permits the opening to be in communication with a region exterior to the base plate; and
a pair of hangers connected to the base plate, the hanger being configured to engage with the stationary member.

12. The mounting bracket of claim 11 wherein the mounting bracket is adjustable with respect to the stationary member.

13. The mounting bracket of claim 11 wherein the mounting bracket is fixedly attached to the stationary member.

14. The mounting bracket of claim 11 wherein the base plate includes a front surface and a back surface wherein the elongated recess located in the back surface of the base plate.

15. The mounting bracket of claim 11 further comprising a cover plate attached on the front surface of the mounting bracket.

16. The mounting bracket of claim 11 wherein the hanger is detachably connected at one end of the base plate.

17. A mounting bracket for positioning an electronic device relative to a frame of a forklift truck comprising:
a base plate having a pair of openings therethrough wherein each of the pair of openings receives an electronic device therein, each of the pair of openings includes an elongated recess extending from the opening of the base plate, the elongated recess permits the opening to be in communication with a region exterior to the base plate;
a pair of hangers connected to the base plate, each of the hanger being configured to engage with the forklift truck; and
a cover plate configured to enclose each of the pair of the opening so as to protect the electronic device.

18. The mounting bracket of claim 17 wherein the mounting bracket is adjustable with respect to the frame.

19. The mounting bracket of claim 17 wherein the mounting bracket is fixedly attached to the frame.

20. The mounting bracket of claim 17 wherein the base plate includes a front surface and a back surface wherein the elongated recess are located in the back surface of the base plate.
